(19) United States
(12) Patent Application Publication
(10) Pub. No.: US 2016/0132879 A1
(43) Pub. Date: May 12, 2016

(54) SYSTEM AND METHOD FOR ENFORCING DIFFERENTIAL PRICING

(71) Applicant: MasterCard International Incorporated, New York, NY (US)

(72) Inventor: Justin X. Howe, San Francisco, CA (US)

(73) Assignee: MASTERCARD INTERNATIONAL INCORPORATED, New York, NY (US)

(21) Appl. No.: 14/539,793

(22) Filed: Nov. 12, 2014

(51) Int. Cl. G06Q 20/40

(52) U.S. Cl. CPC G06Q 20/405

(57) ABSTRACT

Systems and methods are provided for enforcing differential pricing and other pricing structures using a payment network. One embodiment of the payment network includes a server, a processor, and a memory module that includes stored computer program code. The memory module, the stored computer program code, and the processor are configured to cause the server to parse a request message associated with a payment transaction to obtain an item identifier and payment mechanism information. The item identifier is associated with an item to be purchased as part of the payment transaction. The payment mechanism information is associated with a payment mechanism. The memory module, the stored computer program code, and the processor are further configured to cause the server to obtain a determination of whether, based on the payment mechanism information, the payment mechanism complies with a set of pricing control rules associated with the item. Additionally, the memory module, the stored computer program code, and the processor are further configured to cause the server to transmit a response message approving the payment transaction request, upon a determination that the payment mechanism complies with the set of pricing control rules, and to transmit a response message declining the payment transaction request, upon a determination that the payment mechanism does not comply with the set of differential rules.

### TECHNICAL FIELD

The present disclosure relates generally to electronic transaction processing. More particularly, the present disclosure is directed to systems and methods for enforcing differential pricing and other pricing structures using a payment network that authorizes payment based on pricing control rules associated with items being purchased.

### BACKGROUND

The use of payment cards for a broad spectrum of cashless transactions has become ubiquitous in the current economy, accounting for hundreds of billions of dollars in transactions per year. For example, MasterCard International Incorporated, one example of a payment card network, processes millions of transactions per hour across 230 countries. Aspects involved with the use of payment cards include the authentication of the payor/consumer using the payment card, as well as the authorization of the transaction based upon the availability of monies in the payor's/consumer's bank account.

In addition, the rise of e-commerce, or transactions carried out over the Internet, has led to the frustration of efforts to implement differential and other pricing structures and structures. For example, publishers often attempt to sell items at different prices in different countries. But e-commerce merchants have undercut these attempts by exploiting the price differentials—buying the items from countries with low prices and selling the items into countries with high prices. Under current law, publishers may have no recourse in copyright protection to thwart this exploitation. Moreover, conventional, serial pursuit of “fly-by-night” and other exploiters costs publishers valuable time and resources. As such, exploitation of pricing differentials dis-incentivizes publishers from selling items pursuant to differential pricing structures, for example, by selling items at lower prices in certain countries. This disincentive may create a barrier to access to the items in those countries in which the items are typically associated with lower prices. For example, such a barrier may take the form of increased prices, or of simply halting sales in those countries.

### SUMMARY

In view of the above shortcomings in conventional attempts to implement and enforce differential pricing and other pricing structures, there exists a long-felt need for a payment network that facilitates enforcing differential and other pricing structures, including pricing structures implemented across multiple geographic regions, particularly with regard to items bought and sold in e-commerce transactions. Moreover, there exists a long-felt need for a payment network that provides insight into the effectiveness of such pricing structures and the enforcement thereof. Embodiments of the present disclosure include systems and methods for enforcing differential pricing and other pricing structures, including over cashless payment networks, including over both traditional and Internet transactions, and including for items that are shipped and/or downloaded or streamed instantly.

In accordance with one embodiment of the disclosure, a payment network for enforcing differential pricing and other pricing structures includes a server, a processor, and a memory module that includes stored computer program code. The memory module, the stored computer program code, and the processor are configured to cause the server to parse a request message associated with a payment transaction to obtain an item identifier associated with an item to be purchased as part of the payment transaction, and to obtain payment mechanism information associated with a payment mechanism. The item includes published content in the form of conventional (e.g., written or stored) media or digital media, in one implementation of the disclosed payment network. The item identifier, in one embodiment, is provided from one of a mobile device payment application and a merchant point-of-sale (POS) terminal. In this embodiment, the request message is contained in an authorization request message.

The server is further caused to obtain a determination of whether, based on the payment mechanism information, the payment mechanism complies with a set of pricing control rules associated with the item. Moreover, the server is caused to transmit a response message approving the payment transaction request, upon a determination that the payment mechanism complies with the set of pricing control rules; and to transmit a response message declining the payment transaction request, upon a determination that the payment mechanism does not comply with the set of pricing control rules.

In one example implementation, the set of pricing control rules includes a geographical territory associated with the item. In this example implementation, the payment mechanism complies with the set of pricing control rules only if the payment mechanism was issued within the geographical territory associated with the item. In a further illustrative example, the set of pricing control rules includes a geographical territory and a minimum price for the item. The minimum price is specific to the geographical territory. In this illustrative example, the payment mechanism complies with the set of pricing control rules only if the payment mechanism was issued within the geographical territory and a purchase price of the item is greater than or equal to the minimum price.

One embodiment of the disclosed payment network includes a clearing system configured to process clearing and settlement associated with the payment transaction, only after the determination that the payment mechanism complies with the set of pricing control rules. In an example implementation, the clearing system is configured to withhold from processing clearing and settlement associated with the payment transaction, subsequent to the determination that the payment mechanism does not comply with the set of pricing control rules.

### BRIEF DESCRIPTION OF THE DRAWINGS

Further aspects of the present disclosure will be more readily appreciated upon review of the detailed description of the various disclosed embodiments, described below, when taken in conjunction with the accompanying figures.

FIG. 1 illustrates an example payment card transaction processing system in which differential pricing and other pricing structures related to an item may be enforced in accordance with various embodiments of the disclosure.

FIG. 2 illustrates an additional example payment card transaction processing system in which differential pricing and other pricing structures related to an item may be enforced in accordance with various embodiments of the disclosure.

FIG. 3 illustrates an example communications system in which various embodiments of the disclosure may be implemented.

FIG. 4 is an example flow diagram illustrating various operations that may be performed to enforce differential pricing and other pricing structures related to an item in accordance with various embodiments of the disclosure.

FIG. 5 is an example flow diagram illustrating various operations that may be performed to enforce differential pricing and other pricing structures related to an item in accordance with additional embodiments of the disclosure.

FIG. 6 illustrates an example computing module that may be used to implement features of various embodiments of the disclosure.

The figures are described in greater detail in the description and examples below, are provided for purposes of illustration only, and merely depict typical or example embodiments of the disclosure. The figures are not intended to be exhaustive or to limit the disclosure to the precise form disclosed. It should be understood that the disclosure may be practiced with modification or alteration, and that the disclosure may be limited only by the claims and the equivalents thereof.

### DETAILED DESCRIPTION

The present disclosure is directed to systems and methods for enforcing differential pricing and other pricing structures. The details of some example embodiments of the systems and methods of the present disclosure are set forth in the description below. Other features, objects, and advantages of the disclosure will be apparent to one of skill in the art upon examination of the present description, figures, examples, and claims. It is intended that all such additional systems, methods, features, and advantages be included within this description, be within the scope of the present disclosure, and be protected by one or more of the accompanying claims.

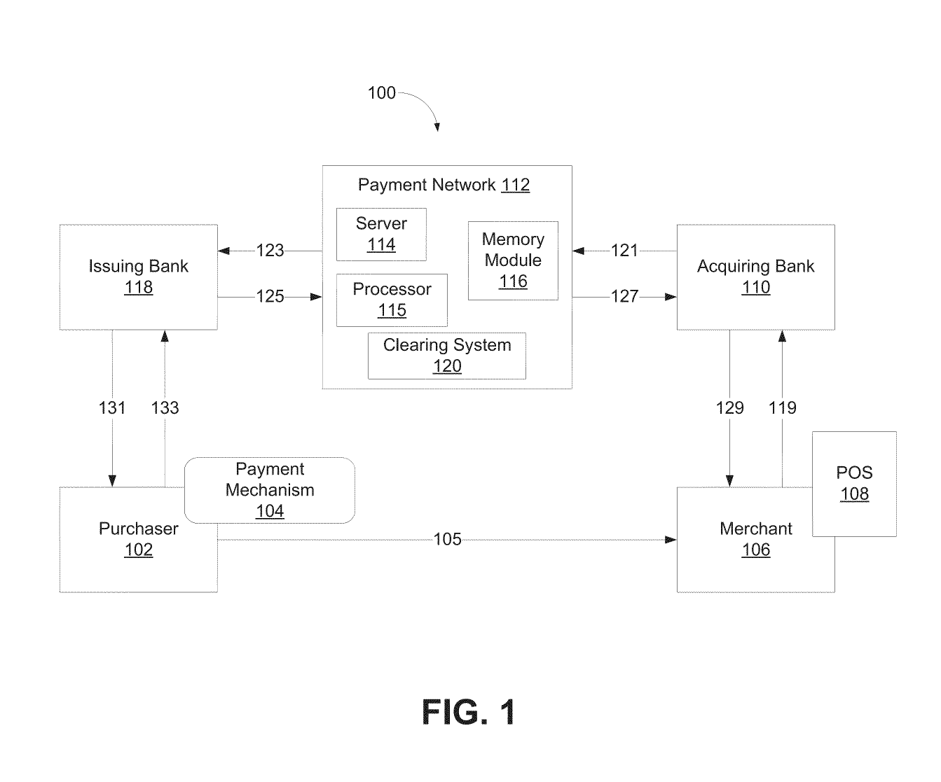

As the present disclosure is directed generally to electronic transaction processing, the following description provides relevant context for the embodiments described herein. Transaction processing of electronic payments may include both an authorization side and a clearing side. The authorization side may involve the process of confirming that a cardholder has a sufficient line of credit to cover a proposed payment for an item. The clearing side of the transaction may involve reconciliation between the issuing bank and an acquiring bank—e.g., determining the amount owed by the issuing bank to the acquiring bank or vice versa. Later on, funds may be exchanged between the issuing bank and the acquiring/merchant bank, typically based on the clearing process. FIG. 1 depicts example payment card transaction processing system 100 for enforcing differential pricing and other pricing structures. System 100 includes both the authorization side and the clearing side of card-based payment transactions.

In a typical card-based payment system transaction (or purchase transaction), purchaser 102 presents payment mechanism 104, which in various embodiments is a credit/debit/prepaid card, to merchant 106 for the purchase of an item. The above-described purchase transaction is indicated by arrow 105. The item may be a good and/or a service. Goods may include published content, such as in conventional books, magazines, periodicals, journals (including academic publications), music (e.g., CD, vinyl record, cassette tape, streaming), multimedia, and video (e.g., VHS, DVD, Blu-ray Disc™, Ultra HD, and the like), as well as digital forms thereof (e.g., streaming content, downloaded/downloadable content, and the like, including audio, video, photo, etc.). Published content may also include, for example, subscription media, such as provided by Netflix®, Hulu™, Amazon.com®, iTunes®, SoundCloud®, and the like. Services may include any service, such as repair or maintenance (e.g., wristwatch repair), general contracting services, plumbing, carwash services, and so on. Generally, the present disclosure is directed to services that vary in price according to geography.

“Payment mechanism” 104 or “payment card,” as used herein, may also refer to a conventional magnetic-stripe credit or debit card, or similar proximity payment device (utilized on its own or incorporated into another device such as a mobile telephone, personal digital assistant (PDA), etc.) having near field communications (NFC) capabilities, such as a radio frequency identification (RFID) chip implemented therein. “Payment mechanism” 104 or “payment card” may also further refer to virtual or limited-use account numbers and electronic wallets and the like.

It will be understood by those of ordinary skill in the art that, prior to the occurrence of such a transaction, purchaser 102 was issued payment mechanism 104 by issuing bank 118. Moreover, it will be understood that merchant 106 has established a relationship with acquiring bank 110, thereby allowing merchant 106 to receive payment mechanism 104 (e.g., credit/debit cards) as payment for items. That is, merchant banks and issuing banks may participate in various payment networks, including payment network 112. One such payment network is operated by MasterCard International Incorporated, the assignee of the present disclosure.

After presentation of payment mechanism 104 to merchant 106 by purchaser 102, merchant 106 may send a request message (indicated by arrow 119), which in some embodiments may be all or part of an authorization request, to acquiring bank 110 via a point-of sale (POS) terminal 108 located at or otherwise controlled by merchant 106. In turn, acquiring bank 110 communicates with payment network 112 (indicated by arrow 121), and payment network 112 communicates with issuing bank 118 (indicated by arrow 123) to determine whether purchaser 102 is authorized to make transaction 105. Issuing bank 118 either approves or declines the authorization request and thereafter transmits the response back to merchant 106 (indicated by arrows 125, 127, and 129). Merchant 106 may then either complete or may cancel purchase transaction 105, based upon the response to the authorization request.

If purchase transaction 105 is approved, the transaction amount associated therewith will be sent from issuing bank 118 through payment network 112 to acquiring bank 110. The transaction amount, minus certain fees, will thereafter be deposited within a bank account belonging to merchant 106, in accordance with a process called settlement. Issuing bank 118 thereafter bills purchaser 102 (indicated by arrow 131) for all purchase transactions conducted over a given period of time by sending a statement to purchaser 102. Purchaser 102 follows by submission of payment(s) (as indicated by arrow 133) to issuing bank 118. This submission of payment(s) (as indicated by arrow 133) by purchaser 102 may be automated (e.g., in the case of debit transactions), may be initiated by purchaser 102 for the exact amount matching amounts of purchases during the statement period (e.g., charge cards or credit balances paid in full), and/or may be submitted (in part or in whole) over a period of time that thereby reflects the amount of the purchases, plus any financing charges agreed upon beforehand between purchaser 102 and issuing bank 118 (e.g., revolving credit balances).

Payment network 112 includes at least one server 114 and at least one memory module 116. Server 114 may include various computing devices such as a mainframe, personal computer (PC), laptop, workstation, smartphone, tablet, or the like. Server 114 may include a processing device and may be configured to implement an authorization and clearing process, with such configuration and/or associated instructions being stored in computer storage associated with server 114. Memory module 116 may include computer readable medium storage technologies, such as a floppy drive, hard drive, tape drive, flash drive, optical drive, read-only memory (ROM), random access memory (RAM), and/or the like. Server 114 and memory module 116 may be controlled by software/hardware and may store data to allow memory module 116 to operate in accordance with aspects of the present disclosure. POS terminal 108 is in data communication, directly or indirectly, and at least from time to time, with, e.g., an acquirer host computer (not shown) that is part of payment network 112, and that is operated for or on behalf of acquiring bank 110, which handles payment card transactions for merchant 106. Server 114 may be operated by or on behalf of the payment network 112, and may provide central switching and message routing functions among the member financial institutions of payment network 112. Issuing bank 118 also may make use of an issuer host computer (not shown), and an access point (not shown), via which the issuer host computer exchanges data messages with server 114.

It should be noted that, in practice, payment card transaction processing system 100 may involve a large number of cardholders/purchasers 102, POS terminals 108, merchants 106, acquirer host computers, issuer host computers, and access points. In general, the acquirer host computer may receive authorization requests from POS terminals, forward the authorization requests through payment network 112, receive authorization responses, and relay the authorization responses to POS terminal 108. Moreover, the issuer host computer may, in general, receive authorization requests from server 114 and transmit authorization responses back to server 114 based on the authorization requests.

It should also be noted that the terms “authorization” and “authentication” may have distinct definitions in the context of electronic payment transactions. For example, the term authorization may refer to (as described above) the process by which issuing bank 118 approves or declines a transaction based on the availability of the requisite funds. Authentication may refer to the process of establishing the validity of payment mechanism 104 and/or the account information associated with payment mechanism 104 provided by purchaser 102. Authentication may be accomplished by manual processes such as verifying card ownership via physical ID (e.g., driver's license) and/or by utilizing one or more fraud prevention tools, such as an address verification service (AVS), card security codes (CVS)/card verification data (CVD), card verification code (CVC2), and the like. Moreover, merchant 106 may further utilize other authentication methods or processes, including certain geolocation authentication mechanisms. In the case of debit payment transactions reliant upon the use of debit cards, a personal identification number (PIN) may be used for cardholder authentication. In accordance with various embodiments, authorization and/or authentication processes may be considered to be encompassed by the exchange of authorization information (e.g., authorization request and/or authorization responses/approval/decline messaging described herein).

Also included in a typical card-based payment system transaction are the clearing and settlement processes described above. Clearing (which may happen after transmission of the authorization response if approved) may refer to a process by which issuing bank 118 exchanges transaction information with acquiring bank 110 (also referred to as merchant bank). Referring back to FIG. 1, acquiring bank 110 may transmit transaction information to payment network 112, which may include clearing system 120. Clearing system 120 may validate the transaction information and forward it to issuing bank 118, which prepares data to be included on a payment statement for purchaser 102. Clearing system 120 may then provide reconciliation data to both issuing bank 118 and acquiring bank 110.

Settlement may refer to a process by which issuing bank 118 exchanges the requisite funds with acquiring bank 110 to complete an approved transaction. In particular, acquiring bank 110 may send clearing data in a clearing message to payment network 112, whereupon payment network 112 calculates a net settlement position and sends advisement to acquiring bank 110 and issuing bank 118. Issuing bank 118 may remit payment to payment network 112, which then sends the payment to acquiring bank 110. Acquiring bank 110 then pays merchant 106 for the purchase made by purchaser 102, and issuing bank 118 bills purchaser 102.

As previously alluded to, authentication/authorization procedures may typically be part of cashless/electronic payment transactions. For example, without the ability to verify that a person/entity making a payment is authorized to make payment using, e.g., a credit card, such payment transactions may be risky in terms of veracity, and the system may potentially become compromised. The same may hold true for ensuring that the person/entity has the requisite funds to complete the payment transaction. The need for verification, however, may be used in novel ways to implement enforcement of a differential or other pricing structure, as described herein. In particular, an item licensor selling or providing an item may provide a set of pricing control rules associated with the item to payment network 112, for example. Moreover, the item licensor may engage payment network 112 to prevent authorization/clearing of purchase transactions for items when a payment mechanism does not conform to the pricing control rules.

For example, the use of such an authentication/enforcement system may rely on a payment transaction for the item to be completed before distributing/dispensing the item. That is, in order for an item licensor, who is selling or providing an item, to prevent the item from being shipped, the item licensor may need the ability to prevent clearing, even when payment has presumably already been made to a vendor, such as merchant 106 (e.g., by some form of electronic payment). Hence, any realization that the already-purchased item does not conform to the set of pricing control rules typically may need to occur before clearing.

Moreover, and besides the potential monetary loss, enforcement and/or regulatory actions against “fly-by-night” operations may be delayed or near-impossible once the payment transaction has been completed and the pricing-differential exploiter has fled/moved operations. As such, it may also be beneficial for the item licensor to, in real time, prevent authorization of payment when items do not comply with the pricing control rules. This may be particularly applicable when dealing, for example, in streaming content that purchasers 102 expect to receive instantly, and thus removing clearing as an enforcement mechanism. Further still, the payment transaction may, for example, be halted/declined in the event that the payment mechanism does not conform to the pricing control rules for the particular item (e.g., payment card issued outside a prescribed territory), thereby avoiding any potential items/merchants flouting the pricing structure and/or providing the ability for any enforcement, regulator, reporting agency, or item licensor to effect action against a dealer, manufacturer, or merchant much sooner than otherwise.

Hence, systems and methods are provided for integrating a system of pricing control rules with electronic payment authorization/authentication. In accordance with various embodiments of the disclosure, pricing control rules may be associated with, for example, a numeric or alpha-numeric identifier of an item, a quick-response (QR) code, a stock keeping unit (SKU), a universal product code (UPC), a manufacturer part number (MPN), a European article number (EAN), or an international standard book number (ISBN), or some combination thereof. And the pricing control rules may be included, embedded, or otherwise integrated into a payment authorization/authentication message that is generally sent with authorizing an electronic payment transaction. In this way, the process of enforcing or implementing a differential pricing or other pricing structure may be streamlined. Furthermore, the increased security associated with payment transaction authorization procedures may serve to also make the implementation of the pricing control rules more secure. For example, payment card information that passes through system 100 may be tokenized.

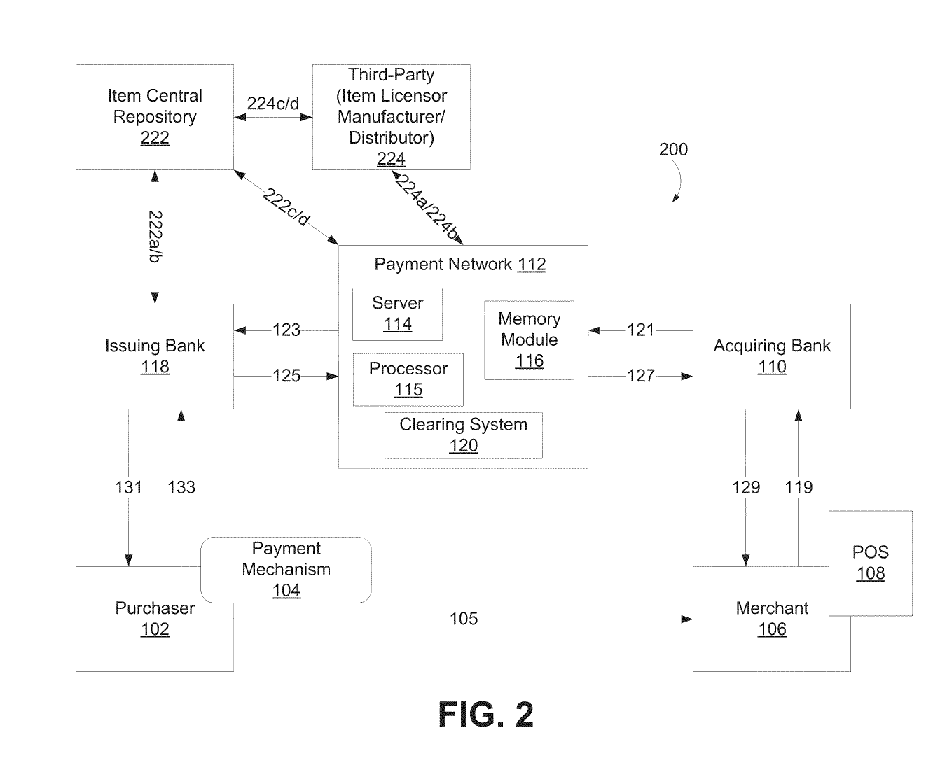

FIG. 2 illustrates example payment card transaction processing system 200, in which differential pricing enforcement may be integrated in accordance with various embodiments of the disclosure. Elements of system 200 may be considered to be the same or similar to like-numbered elements of FIG. 1, e.g., purchaser 102, payment mechanism 104, merchant 106, POS 108, acquiring bank 110, payment network 112 (and the example constituent elements thereof), and issuing bank 118. In addition to these elements, system 200 may further include a verification entity, such as item central repository 222, in which a determination may be made regarding whether payment mechanism 104 complies with the set of pricing control rules for an item. Item central repository 222 may include one or more servers, processors, and/or memory modules that may receive, e.g., payment mechanism information, and compare that payment mechanism information with pricing control rules previously stored in item central repository 222.

Additionally, system 200 may include connectivity to third-party 224, such as an item licensor, product manufacturer, distributor, content provider, service provider, and the like. Such connectivity between payment network 112 and third-party 224 may allow payment network 112 to, e.g., notify third-party 224 when and/or where a payment transaction request is declined, if, for example, the payment mechanism information does not comply with the pricing control rules associated with an item supplied by third-party 224 (or a distributor). Third-party 224 may also be communicatively connected to item central repository 222, such that item central repository 222 may assume the task of notifying third-party 224 when or where a transaction request is declined.

The aforementioned integration of differential pricing enforcement with payment authorization/clearing, as well as such notification, may occur in real-time or near-real-time. In accordance with other embodiments, such as may be the case in e-commerce payment transactions (e.g., web-based online purchases), some delay may be introduced, but in either scenario, enforcement actions regarding differentially priced items may be initiated and/or performed much sooner than in conventional systems because the disclosed rule-controllable payment authorization/clearing provides third-party 224 with the ability to preempt the purchase transaction before it is completed (e.g., before payment has been accepted).

As described above, item information may be embedded or otherwise included in a payment authorization (e.g., request) message to effect differential pricing enforcement. In accordance with one embodiment, an item identifier, such as a unique serial number, SKU, UPC, or other identifying information, may be added to payment transaction data as part of a cashless or electronic payment transaction. For example, and in a retail setting, the item identifier may be added to data that is conventionally gathered, e.g., an account number associated with payment mechanism 104, an identification number of merchant 106/POS terminal 108, a transaction amount, etc. That is, a retail clerk at merchant 106 may manually enter the item identifier as another piece of transaction data.

In accordance with another embodiment, and in the event payment mechanism 104 is, e.g., a debit card, purchaser 102 in possession of payment mechanism 104 may enter the item identifier in addition to the entry of a PIN associated with payment mechanism 104. Additionally, an application such as an interactive graphical user interface (GUI) may be displayed to purchaser 102 at POS terminal 108 that allows purchaser 102 to enter the item identifier. The interactive GUI may be added to the hardware and/or software used to implement POS terminal 108. For example, certain POS devices may already utilize an interactive GUI that, e.g., captures a consumer's signature or other identifying information in order to authorize purchases. Capturing of the item identifier may be added as another aspect of such an interactive GUI.

Other embodiments may utilize a mobile device payment application, such as may be implemented as a payment application on a tablet PC, a smartphone, or similar device. That is, the mobile device may act as a POS terminal. Accordingly, the mobile device payment application may include a mechanism—such as an interactive GUI—that, in addition to capturing conventional transaction data, may also allow for the entry of an item identifier of an item to be compared (along with the payment mechanism information) to the pricing control rules, for example, by payment network 112.

To illustrate, purchaser 102 may initiate and/or log on to such a mobile device payment application. Thereafter, purchaser 102 may enter (or, e.g., select) the item identifier. Additionally, the mobile application may be configured to, e.g., scan the item identifier from a barcode located on the item. Or, where the item is being purchased electronically, the mobile application may obtain the item identifier from the online retailer (e.g., Amazon.com®) through an Internet connection. Purchaser 102 may have payment mechanism 104 pre-associated with the mobile device payment application, and the payment mechanism information may be obtained via the mobile device payment application based on this pre-association.

In particular, and once the item identifier is included in or with the transaction data, the item identifier may be transmitted through system 200 in an authorization (e.g., request) message as previously described. That is, and after presentation of payment mechanism 104 to merchant 106 by purchaser 102, merchant 106 may send an authorization request (or, e.g., request message associated with the payment transaction) including the item identifier and transaction data (indicated by arrow 119) to acquiring bank 110 via POS terminal 108 located at or otherwise controlled by merchant 106. Additionally, the payment mechanism information may be embedded in the authorization request.

In turn, acquiring bank 110 communicates with payment network 112 (indicated by arrow 121). Payment network 112 may parse the request message to obtain the included item identifier and/or the payment mechanism information. Payment network 112, using, e.g., an application programming interface (API), may make a call to item central repository 222 to obtain a determination of whether, based on the payment mechanism information, the payment mechanism complies with the set of pricing control rules associated with the item (indicated by arrow 222c). Additionally, payment network 112 may bypass item central repository 222 and may process the payment mechanism information and item identifier to determine compliance with the pricing control rules. Regardless, it should be noted that, although FIG. 2 depicts a single item central repository 222, there may be multiple repositories that payment network 112 may access (e.g., for different types of items). Additionally, such a repository need not be centralized, but may be embodied as a distributed system/network of repositories, or a hybrid combination of a centralized and distributed repositories.

If the payment mechanism is determined not to comply with the pricing control rules—for example, if the item identifier indicates that the item is not intended for a geographic region associated with the payment mechanism (as will be further described below)—item central repository 222 may indicate this determination to payment network 112 (indicated by arrow 222d). Payment network 112 may then generate a response message. That is, payment network 112 may indicate to issuing bank 118 that the payment transaction request violates the pricing control rules. This may be done in a separate message or as part of the typical communication with issuing bank 118 (indicated by arrow 123) to determine whether purchaser 102 is authorized to make transaction 105. Issuing bank 118 may then decline the authorization request and thereafter transmit the response message back to merchant 106 (indicated by arrows 125, 127 and 129). Alternatively, payment network 112 may wait for issuing bank 118 to decline the authorization request based on, e.g., available funds/purchaser 102 authentication, and then transmit the response.

In any case, after server 114 obtains a determination of whether, based on the payment mechanism information, payment mechanism 104 complies with the set of pricing control rules associated with the item, server 114 may be caused (e.g., by memory module 116 and processor 115) to transmit the response message. If server 114 obtains a determination that payment mechanism 104 complies with the set of pricing control rules, server 114 may be caused to transmit a response message approving the payment transaction request. If, however, server 114 obtains a determination that payment mechanism 104 does not comply with the set of pricing control rules, server 114 may be caused to transmit a response message declining the payment transaction request.

Payment network 112 may then add an indication regarding any additional bases for declining the request (e.g., that the payment transaction request violates the pricing control rules) in the response message back to merchant 106 (indicated by arrows 127 and 129) or with additional messaging. Merchant 106 may then cancel transaction 105 based upon the response message to the authorization request (or request message). If the payment transaction is approved, based on a determination that the payment mechanism complies with the pricing control rules, messaging indicating this may be transmitted/exchanged between the elements of system 200 in a manner substantially similar as described above with regard to system 100, whereupon merchant 106 may ultimately complete transaction 105.

In accordance with another embodiment, it may be issuing bank 118 that makes the determination to approve/decline the transaction. That is, payment network 112 may receive a message/indication (indicated by arrow 222c/d) from item central repository 222 that the transaction should be approved or declined based on whether the payment transaction request complies with the pricing control rules. Payment network 112 may then suggest that issuing bank 118 approve/decline the authorization request (or request message) as part of the “standard” approval/decline message 125 to payment network 112 and/or via separate and/or additional messages, and ultimately to acquiring bank 110 and merchant 106.

As described above, certain delays may be encountered in some e-commerce scenarios—for example, where purchased items must be shipped. Advantageously, such delays may allow for monitoring/enforcement of compliance with the pricing control rules to be integrated into the clearing process, rather than the authorization process, in accordance with some embodiments. That is, and in e-commerce scenarios, there may be a delay in the transaction, e.g., between purchase order submission by purchaser 102, and obtaining the ordered product after it is shipped. Thus, in an e-commerce scenario, conventional authorization to verify available funds and/or the proper cardholder may be performed. Thereafter, and once an item is obtained/ready for shipment, merchant 106 may embed/append an item identifier in the transaction information (e.g., when acquiring bank 110 transmits transaction such information to payment network 112).

In this way, the item and payment mechanism 104 in this example may be compared to the pricing control rules (in a substantially similar manner as that described above in a non-e-commerce scenario), but it is clearing system 120 of payment network 112 that may parse the item identifier from the transaction information and verify that the payment transaction request conforms to the pricing control rules (e.g., via item central repository 122 or otherwise). Then, if the payment transaction request (or request message) conforms to the pricing control rules, the product may be shipped and settlement may be initiated with the transmission of the clearing data in a clearing message from acquiring bank 110 to payment network 112. If the payment transaction request does not conform to the pricing control rules, the clearing message may be withheld, and the appropriate notification/messaging may be transmitted/exchanged, and subsequent actions for handling suspect transaction requests (some of which have already been discussed above, and some of which are described below) may be performed.

It should be noted that payment network 112 may communicate with third-party 224 regarding when a transaction request violates or does not comply with the pricing control rules (indicated by arrow 224a). Such communications may include individual instances of violation (or non-compliance) and/or collected reports, statistics, or similar information regarding violations. In addition to indicating when a transaction request, or request message, violates the pricing control rules, payment network 112 may notify third-party 224 and/or provide information about which merchant 106 was involved in the transaction request and, for example, where merchant 106 is located. Such information may be gleaned from merchant identification numbers/codes/data that may be transmitted in transaction data (as described above), or from the location-based technology described herein. Alternatively, or in addition to payment network 112 communicating with third-party 224, item central repository 222 may also communicate with third-party 224 (indicated by arrow 224c) regarding the discovery of transaction requests in violation of or non-compliance with the pricing control rules, for example, to provide statistical metrics about items that may be more prone to invite violation of the pricing control rules. By way of illustration, a particular text book may be particularly popular to buy in Brazil and sell in the United States (e.g., due to the pricing differential for the book in those two countries).

Returning to FIG. 2, an entire request, authorization, or clearing message may, in some instances, be sent to item central repository 222, where item central repository 222 may parse the request message to obtain the data fields having the item identifier and the payment mechanism information, respectively. Additionally, payment network 112/clearing system 120 may parse the request/authorization/clearing message in order to extract the item identifier and payment mechanism information for authentication at item central repository 222, or, for example, to be processed locally in payment network 112. It should be noted that, in the event the item identifier is different from, e.g., a UPC or SKU-level code, such UPC or SKU information could be included in the transaction data in accordance with certain conventional payment transactions. However, and from a privacy perspective, some embodiments may strip or prevent the transmittal of UPC, SKU, or other information that could link a purchaser to the use of certain items. Accordingly, in some embodiments, only the item identifier and payment mechanism information are included in the transaction data/information associated with the request message, in order to protect purchaser privacy with regard to sensitive purchases. In further embodiments, privacy may be enhanced through secure or other tokenization of the UPC/SKU and/or other transaction data.

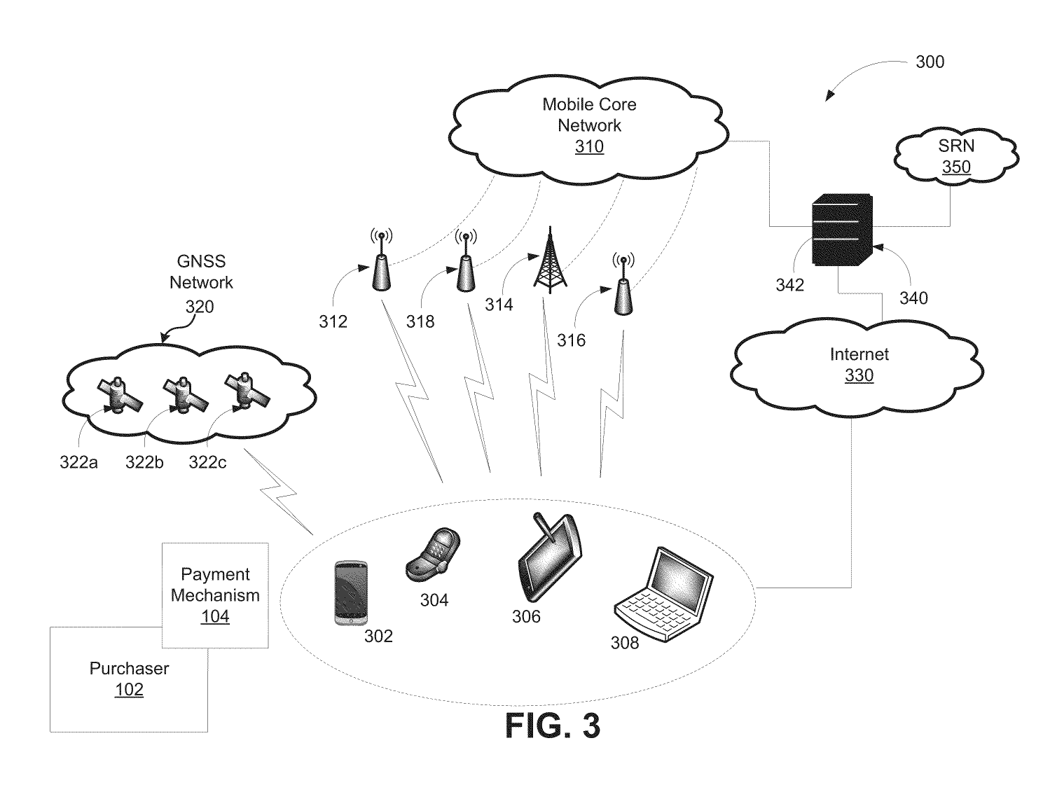

In the case of mobile device payment scenarios, the aforementioned mobile device payment application may be able to glean, e.g., geo-location information, or other merchant or purchaser identifying information. FIG. 3 is a block diagram illustrating example communications system 300, in which various embodiments may be implemented in accordance with the present disclosure. Referring to FIG. 3, communications system 300 includes a plurality of mobile devices 302-308. One or more of mobile devices 302-308 may include the aforementioned mobile device payment application for effecting electronic/cashless payment transactions and differential pricing rule enforcement, according to various embodiments described in the present disclosure.

Example mobile devices may include smartphone 302, cellular device 304, personal digital assistant (PDA) 306, and/or tablet PC 308. Also shown in communications system 300 is mobile core network 310, wireless access point (AP or WAP) 312, cellular base station (BS) 314, Bluetooth® emitter 316, Near Field Communication (NFC) terminal 318, global navigation satellite system (GNSS) network 320, plurality of GNSS satellites 322a-322n, internet 330, location server 340, and satellite reference network (SRN) 350. One or more of mobile core network 310, WAP 312, cellular BS 314, Bluetooth® emitter 316, NFC terminal 318, GNSS network 320, GNSS satellites 322a—n, internet 330, location server 340, and/or SRN 350, may be used in assisting to determine the location of one or more of mobile devices 302-308 for use in the application and/or to provide communications links to mobile devices 302-308 for allowing mobile devices 302-308 to communicate as described herein with respect to differential pricing enforcement and payment transaction processing.

WAP 312 may include suitable logic, circuitry, interfaces, and/or code that are operable to provide data services to communication devices, such as one or more of mobile devices 302-308, in adherence with one or more wireless LAN (WLAN) standards, such as, IEEE 802.11, 802.11a, 802.11b, 802.11d, 802.11e, 802.11n, 802.11 ac, 802.11v, and/or 802.11u. WAP 312 may communicate with mobile core network 310 and/or internet 330, via one or more links and/or associated devices, for example. In this manner, WAP 312 may provide network access to mobile devices 302-308.

Cellular BS 314 may include a cellular broadcast station, and may include suitable logic, circuitry, interfaces, and/or code that are operable to provide voice and/or data services to communication devices, such as one or more of mobile devices 302-308, in adherence with one or more cellular communication standards. Example cellular communication standards may include Global System for Mobile communications (GSM), General Packet Radio Services (GPRS), Universal Mobile Telecommunications System (UMTS), Enhanced Data rates for GSM Evolution (EDGE), Enhanced GPRS (EGPRS), 3GPP Long Term Evolution (LTE), and so on. Cellular BS 314 may communicate with mobile core network 310 and/or internet 330 via one or more backhaul links and/or associated devices, for example. In this manner, cellular BS 314 may provide network access to mobile devices 302-308, enabling a mobile device (e.g., smartphone 302) running a mobile device payment application to communicate with one or more databases, services, servers, etc., as described herein.

Bluetooth® emitter 316 may include suitable logic, circuitry, interfaces, and/or code that are operable to provide Bluetooth® based connectivity to communication devices, such as one or more of mobile devices 302-308, in adherence with various Bluetooth® and/or Bluetooth® Low Energy (BLE) standards. Bluetooth® emitter 316 may communicate with mobile core network 310 and/or internet 330 via one or more backhaul links and/or associated devices, for example. In this manner, Bluetooth® emitter 316 may provide network access to mobile devices 302-308, enabling a mobile device running a mobile device payment application to communicate with, e.g., merchant 106/POS terminal 108.

NFC terminal 318 may include suitable logic, circuitry, interfaces, and/or code that may provide NFC-based connectivity to communication devices, such as one or more of the mobile devices 302-308, in adherence with various short-range communication standards, such as the Near Field Communications standards. NFC terminal 318 may communicate with the mobile core network 310 and/or internet 330 via one or more backhaul links and/or associated devices, for example. In this manner, NFC terminal 318 may provide network access to the mobile devices 302-308. One example implementation of an NFC terminal 318 is for use in a contactless payment system and/or for communicating with, e.g., merchant 106/POS terminal 108.

Mobile core network 310 may include suitable logic, circuitry, interfaces, and/or code that are operable to provide interfacing and/or connectivity servicing between access networks, which may be utilized by mobile devices 302-308, and external data networks such as packet data networks (PDNs) and/or internet 330. Mobile core network 310 may correspond to one or more service providers that provide, control, and/or manage network accessibility available via mobile devices 302-308. In this regard, mobile devices 302-308 may access mobile core network 310 via wireless AP 312, cellular BS 314, Bluetooth® emitter 316, and/or NFC terminal 318. Mobile core network 310 may communicate various data services, which are provided by external data networks, to associated user devices such as, for example, mobile devices 302-308. In an example aspect of the disclosure, in instances in which a mobile device payment application is provided to a purchaser device such as smartphone 302, mobile core network 310 may be operable to communicate with location server 340 to obtain location information that may be used by the mobile device payment application to, e.g., ascertain a location of merchant 106 and/or purchaser 102 using the mobile device payment application.

Each of mobile devices 302-308 may include suitable logic, circuitry, interfaces, and/or code for implementing various aspects of the embodiments disclosed herein. In this regard, each of mobile devices 302-308 may be operable to communicate via a plurality of wired and/or wireless connections. Each of mobile devices 302-308 may be operable, for example, to transmit to and/or receive signals from one or more of wireless AP 312, cellular BS 314, Bluetooth® emitter 316, NFC terminal 318, GNSS network 320, and/or internet 330. Also, each of mobile devices 302-308 may be operable to communicate with, and/or receive services provided by internet 330 and/or mobile core network 310. In this regard, mobile devices 302-308 may be operable to utilize mobile device payment applications, which may utilize location server 340.

GNSS network 320 may include suitable logic, circuitry, interfaces, and/or code that may provide navigation information to land-based devices via satellite links. In this regard, GNSS network 320 may include, for example, a plurality of GNSS satellites 322a-322c, each of which is operable to provide satellite transmissions based on a GNSS. Example GNSS systems may include, for example, GPS, GLONASS, Galileo-based satellite system, Beidou, and/or Compass systems. Accordingly, GNSS network 320 may be operable to provide positioning information via downlink satellite links transmitted from one or more of the plurality of GNSS satellites 322a-322c to enable land-based devices, such as mobile devices 302-308, to be location-aware. The plurality of GNSS satellites 322a-322c may directly provide positioning information and/or a land-based device may utilize satellite transmissions from different satellites to determine the device's location using, for example, triangulation-based techniques.

SRN 350 may include suitable logic, circuitry, interfaces, and/or code that are operable to collect and/or distribute data for GNSS satellites on a continuous basis. SRN 350 may include a plurality of GNSS reference tracking stations located around the world to provide A-GNSS coverage all the time in both a home network and/or any visited network. In this regard, SRN 350 may utilize satellite signals received from various GNSS constellations, such as, for example, the plurality of GNSS satellites 322a-322c of GNSS network 320.

Location server 340 may include suitable logic, circuitry, interfaces, and/or code that are operable to provide and/or support location-based services. In this regard, location server 340 may be operable to store and/or process location-related information pertaining to communication devices in system 300, such as one or more of mobile devices 302-308. The location information may be stored in a location reference database 342 in location server 340. Location server 340 may be operable to collect and/or retrieve location information from communication devices. Location server 340 may also be operable to access additional and/or dedicated entities, such as SRN 350, for example, to collect GNSS satellite data, and may be operable to utilize the collected GNSS satellite data to generate GNSS assistance data (A-GNSS data) including, for example, ephemeris data, long term orbit (LTO) data, reference positions and/or time information. Location server 340 may communicate the stored location data when requested to do so.

In operation, location server 340 may be utilized to provide location-based services in system 300. Location server 340 may maintain, for example, location reference database 342, which may include elements corresponding to each of mobile devices 302-308. Location server 340 may access SRN 350 to collect GNSS satellite data, and may utilize the collected GNSS satellite data to generate GNSS assistance data (A-GNSS data) pertaining to the mobile devices 302-308. Location server 340 may also collect and/or retrieve location information directly from mobile devices 302-308, and/or from other associated entities that interact with mobile devices 302-308 in system 300, such as, for example, wireless AP 312, cellular BS 314, Bluetooth® emitter 316, and/or NFC terminal 318. The retrieved location information may be stored in location reference database 342 in location server 340. Location server 340 may communicate the stored location data, e.g., when requested to do so. Location reference database 342, maintained in location server 340, may be modified, refined, and/or updated using retrieved location information. Location information stored and/or maintained by location server 340 may be utilized to augment and/or substitute for location information received and/or generated based on communication with GNSS network 320, for example, when communication with GNSS network 320 is disturbed.

The location data may also be locally generated, and/or maintained thereafter by devices and/or entities other than location server 340. In this regard, location-related data, which typically may be generated and/or maintained by location server 340, may be locally generated, maintained, and/or used by mobile devices 302-308, and/or by service providers thereof. Accordingly, devices and/or entities that typically may be serviced by location server 340, such as mobile devices 302-308, may also perform location-related servicing locally. Furthermore, locally generated and/or maintained location-related data may be uploaded from mobile devices 302-308, and/or service providers thereof, to location server 340. Uploading the location-related data may be performed periodically, on request, and/or based on the configuration of the client devices or entities, and/or location server 340 itself.

The location information stored and/or maintained in location server 340 may be utilized to authenticate, for example, one or more of mobile devices 302-308, users thereof, and/or locations thereof during operations performed by mobile devices 302-308. In this regard, service providers, who may provide access servicing to mobile devices 302-308, may contact location server 340 to request that location server 340 perform authentication procedures, and/or to obtain information necessary for performing the authentication procedures. The service providers may include, for example, cellular, Bluetooth®, WLAN, and/or NFC services providers. For example, a service provider of one of mobile devices 302-308 may request authenticating the mobile device, the associated user, and the associated location at a given instance. Location server 340 may then perform the necessary authentication procedures, which may be based on existing information in location reference database 342, which is maintained by location server 340. Location server 340 may also perform authentication procedures based on current information, which may be obtained by, for example, communicating with the mobile device, to verify its present location and/or connectivity status or parameters. In this regard, location server 340 may communicate with the mobile device using IP packets that may be communicated via internet 330, which may be transmitted to and/or received by the mobile device via its internet connectivity, and/or via its network access via wireless AP 312, cellular BS 314, Bluetooth® emitter 316, and/or NFC terminal 318.

Internet 330 may include a system of interconnected networks and/or devices that enable exchange of information and/or data among a plurality of nodes, based on one or more networking standards, including, for example, Internet Protocol (IP). Internet 330 may enable, for example, connectivity among a plurality of private and public, academic, business, and/or government nodes and/or networks, wherein the physical connectivity may be provided via the Public Switched Telephone Network (PSTN), utilizing copper wires, fiber-optic cables, wireless interfaces, and/or other standards-based interfaces.

Various devices and/or user identification information may be utilized during network access and/or communications, which may be structured, allocated, and/or assigned based on the specific wired and/or wireless protocols that are used to facilitate any such network access and/or communication. For example, in GSM and/or WCDMA based networks, International Mobile Equipment Identity (IMEI) parameters may be utilized to uniquely identify mobiles devices, and these IMEI parameters may also be used and/or traced back to the users of the mobile devices. Service providers may utilize the device and/or user identification information to track mobile devices and/or users. The service providers may track devices and/or users for various reasons, including, for example, billing or usage monitoring, and/or to help locate mobile devices, and/or their users, in cases of emergency and/or law enforcement purposes. Tracking of devices may also be used to provide authorized location-based services and/or real-time device location information, which may be utilized by mobile device payment applications, such as example embodiments of the mobile device payment application according to the present disclosure, running on the mobile device or other devices and/or systems.

Conventional payment transactions may be premised on International Organization for Standardization (ISO) 8583, which defines a message format and communication flow for payment transactions (e.g., financial transaction card originated messages) in electronic fund transfers at a POS terminal. For example, MasterCard International bases authorization communications on ISO 8583. Because ISO 8583 defines system-to-system messaging for secure key exchanges, messaging may be considered secure and appropriate for transmitting an item identifier. Although various embodiments herein may be described in the context of utilizing the ISO 8583 messaging format, other formats, whether known or developed and implemented specifically to address differential pricing over a payment network, may be utilized.

An ISO 8583 message may be made of the following parts: a message type indicator (MTI); one or more bitmaps indicating which data elements are present; and data elements, e.g., the fields of the message. Accordingly, a new message type may be defined to include an item product identifier and payment mechanism information, in addition to conventional transaction data in an authorization message and/or clearing message. Additionally or alternatively, an item identifier and payment mechanism information may be appended to one or more existing/currently defined data fields in an authorization or clearing message.

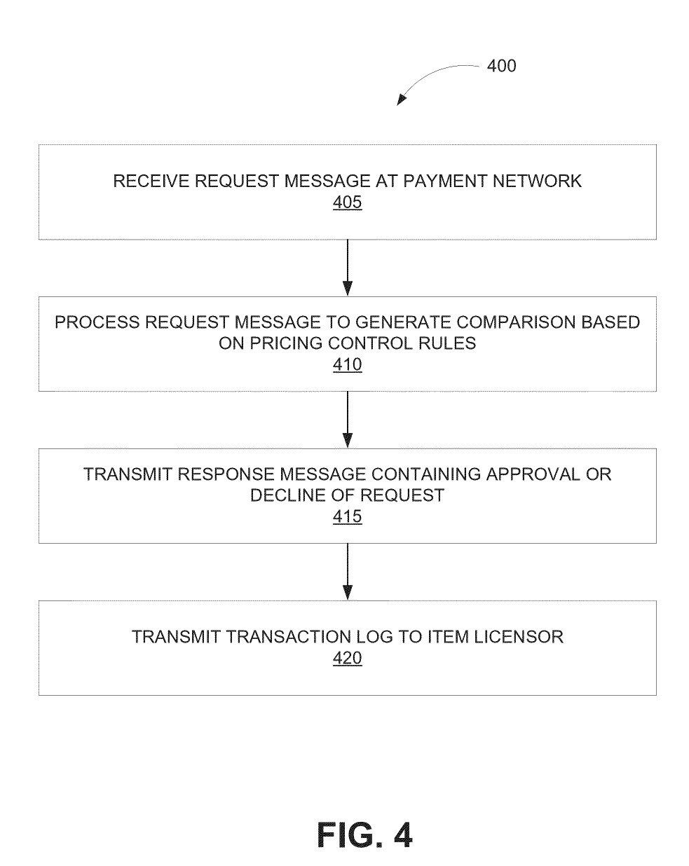

FIG. 4 illustrates a flow chart depicting various operations of method 400 and accompanying embodiments for enforcing a differential pricing or other pricing structure in a payment processing network, in accordance with the present disclosure. The operations of method 400 may be carried out, in some embodiments, by one or more of the components/elements of systems 100 and 200 described above. Method 400 facilitates enforcement of a differential pricing or other pricing structure using a payment network configured to monitor payment transactions and preempt or prevent completions of those transactions that would undercut the pricing structure. For example, in one implementation, a retailer or item licensor may require that, in order for a purchase transaction for an item to be completed, a payment mechanism must be used and must comply with a set of pricing control rules associated with the item. The ability to effect such enforcement may help secure item licensors' ability to sell items at cheaper prices in some areas and more expensive prices in other areas, and to prevent unwanted exploitation of the pricing differential. Exploitation of this kind may force item licensors to sell items at a single price, which may preclude access to the items by some individuals (e.g., individuals in areas where prices would generally be lower). As such, the operations of method 400 may benefit not only the item licensor, but everyone who benefits from differential pricing, including consumers.

Referring again to FIG. 4, at operation 405, method 400 entails receiving a request message at a payment network. The request message may be an authorization request message for a payment transaction, as described herein. As such, the request message may be associated with a request to purchase an item, and the request message may include an item identifier. As described herein, the item identifier may be received, for example and depending on what perspective is being considered, at POS terminal 108, a mobile device payment application, acquiring bank 110, and/or payment network 112. The item identifier may be received pursuant to the initiation of a payment transaction process and/or during processing of a payment transaction. Inclusion of the item identifier may be achieved by embedding the item identifier in an authorization request message as part of a conventional authorization request message, for example, by way of a newly defined data field or as part of an existing data field.

The request message may further include payment mechanism information associated with the payment mechanism to be used for the payment transaction. The payment mechanism information, in various embodiments in which the payment mechanism is a payment card, may include one or more of the card-provider, the country where the card was issued, the purchaser's name/address, the card number, security code, expiration date, BIN number, and any other information associated with the card. The request message may also include location information regarding the purchaser or merchant involved in the payment transaction. Such location information may be obtained, for example, as described hereinabove with regard to FIG. 3, or may be included in association with data received from the processing merchant.

At operation 410, method 400 involves processing the request message to generate a comparison of the payment mechanism information to one or more pricing control rules associated with the item. That is, and during payment or cardholder authorization and/or authentication, the item identifier and payment mechanism information may be determined by, in one example embodiment, parsing the request message (e.g., at payment network 112 and/or by the various sub-elements thereof). In one embodiment of the disclosure, the request message is an authorization message as may be found in a cashless transaction network, described above, and processing the request message is done before the purchase is authorized (e.g., by the issuing bank). In this embodiment, the purchase request is not authorized unless the response message contains an approval.

Another illustrative implementation includes transmitting the item identifier and the payment mechanism information to a verification entity or verification network, such as item central repository 222, to determine if the payment mechanism information complies with the pricing control rules for the item. For example, item central repository 222 or another third-party verification network (which may be associated with the item licensor, may be an agent of the item licensor, etc.) may verify whether the country of issuance of the payment mechanism is the same as the target country for the item. A first target country may be associated with a first price, and a second target country may be associated with a second price. The first and second prices may correspond to the same item, or may correspond to different versions (e.g., editions) of the same item—in such instances, the first and second prices may also be associated with one or more countries.

By way of illustration, the item may be a textbook that a publisher (one example of an item licensor) wishes to sell at a first price in Spain and a second price in France. Moreover, the publisher may wish to target sales of a first version of the textbook for Spain and to target sales of a second version of the textbook for France. Having received, from the publisher (or elsewhere), pricing control rules associated with the various versions of the item (e.g., textbook) and countries at issue, item central repository 222 may compare the country of issuance for the payment mechanism (e.g., based on the payment mechanism information) to the version of the textbook (e.g., as identified in the transaction data/item identifier). The sales price for the item may also be part of this comparison, if the sales price for the item is part of the pricing control rules. In this illustrative example, if the country of issuance is Spain, and the textbook is the second version, item central repository 222 may determine that the payment mechanism, and/or the sales price, does not comply with the pricing control rules. By contrast, if the country of issuance is France and the textbook is the second version, item central repository 222 may determine that the payment mechanism complies with the pricing control rules.

At operation 415, method 400 involves the payment network transmitting a response message based on the comparison described above. The response message contains an approval or a decline of the request to purchase the item, with the approval or decline being based on the comparison. The approval or decline may further be based on additional factors involved in approving a payment transaction through a conventional payment network, as described hereinabove. The response message, in one embodiment, is transmitted to at least one of an acquiring bank associated with a merchant of the item, the purchaser, and an issuing bank associated with a purchaser of the item. In this manner, the acquiring bank may be made aware of the activity of the merchant, particularly with regard to past violations of pricing control rules for specific items the merchant is offering (or that are subject to the request message). The acquirer may, for example, refuse to do business with the merchant or report the purchase to a regulatory agency or the like. In yet another example implementation of the disclosure, the response message may be transmitted to a distributor of the item to prevent the distributor from distributing the item unless the response message contains an approval. This may apply to goods (including streaming content, for example), dispatched services, or any type of item.

A further embodiment of method 400 involves, at operation 420, transmitting a transaction log to the item licensor (represented, e.g., by arrow 224a of FIG. 2). The transaction log may include a set of the request messages, e.g., processed by payment network 112 and the set of response messages transmitted, e.g., by payment network 112. Additionally, each message in the set of request messages may correspond to one of the response messages in the transaction log. In this manner, the transaction log may, for example, be representative of how effective payment network 112 is at implementing the differential pricing enforcement structure promulgated by the item licensor. Further, the transaction log (e.g., via number of denied transaction requests associated with particular items) may be indicative of particular items that are relatively susceptible to erosion/exploitation of the pricing structure, whether a differential pricing structure, volume-based pricing structure, or other. For example, particular items may have a relatively high differential pricing ratio among different geographical regions or territories, or two pricing regions may be relatively close geographically. As such, the pricing differential may be attractive to would-be merchants seeking to exploit the pricing differential. And the transaction log may provide the item licensor with insight into the market's reaction to the pricing structure (e.g., whether the differential is too high or too low).

In one example embodiment, the geographical regions are countries, and the item licensor implements a differential pricing structure on a country-by-country basis. The structure, however, may be geographically based, in other embodiments, or may be based on other factors independent of geography. For example, an item licensor may base the minimum price for a particular item on volume of total sales. As such, the item licensor may sell the item at a first price for the first number of units sold, but may sell the item for no less than a second price after meeting the first number of units sold. In other words, the present disclosure provides an item licensor with relatively tight control over the price at which items are sold, and the item licensor may implement a variety of pricing structures and controls using the enforcement techniques described herein, including implementing tightly controlled, tiered pricing structures. In additional example implementations, the pricing control rules may include a combination of geographical region and minimum price—e.g., each geographical region in a differential pricing structure may be associated with a minimum price at which the item licensor has decided to sell the item.

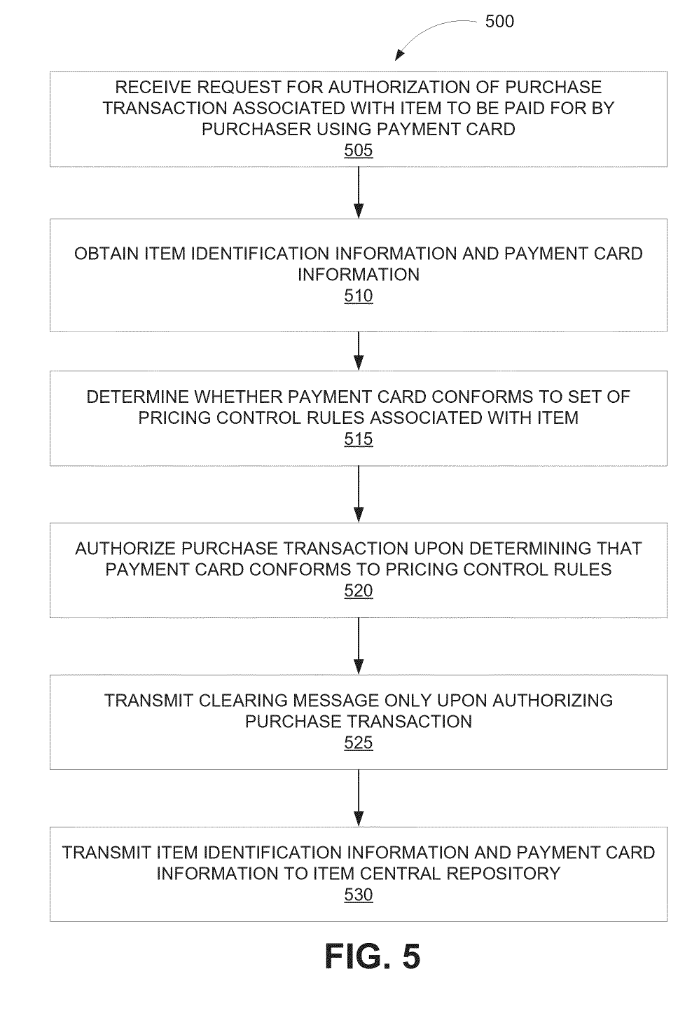

FIG. 5 illustrates a flow chart describing various operations of method 500 that may be performed in order to enforce a differential pricing or other pricing structure using a payment network, in accordance with another embodiment of the disclosure. One embodiment of implementing the operations of method 500 includes a non-transitory computer-readable medium with computer-executable code embodied thereon. The computer-executable code is configured to cause the payment network to perform a number of operations to enforce the pricing structure. Method 500 may be carried out by one or more components/elements of systems 100 and 200, and may, for instance, include one or more operations of method 400.

By way of example, and in an e-commerce scenario, operation 505 involves receiving a request for authorization of a purchase transaction. The purchase transaction is associated with an item to be paid for using a payment card. Operation 510 involves obtaining item identification information and payment card information associated with the request for authorization. The item identification information is associated with the item to be purchased, while the payment card information is associated with the payment card. For example, and as described above, the item identification information may be a SKU number, or other such identification number or data, while the payment card information may identify the country of issuance for the card, to illustrate, and as described above.

Based on the payment card information and the item identification information, at operation 515, method 500 includes determining whether the payment card conforms to a set of pricing control rules associated with the item. In one embodiment, the set of pricing control rules includes a geographic territory specific to the item; and to conform to the pricing control rules, the payment card must have been issued in the geographic territory. If the payment network determines that the payment card satisfies the pricing control rules for the item, method 500 includes authorizing the purchase transaction, at operation 520.

In one example implementation, at operation 525, method 500 includes a clearing system (e.g., clearing system 120) transmitting a clearing message for the purchase transaction only upon authorizing the purchase transaction. In other words, the clearing system may be configured to withhold from processing clearing and settlement associated with the payment transaction when the payment mechanism (e.g., a payment card) does not comply with the set of pricing control rules for the item. In a further embodiment, the payment network is caused to initiate payment settlement subsequent to the clearing system transmitting the clearing message. In other words, the clearing system may be configured to process clearing and initiate settlement associated with the payment transaction subsequent to the determination that the payment mechanism complies with the set of pricing control rules. Operation 530 involves the payment network transmitting the item identifier and payment card information to an item central repository (e.g., item central repository 222) to allow the item licensor to compare the information to a set of pricing control rules, thus providing the ability to enforce and track the effectiveness of the pricing structure.

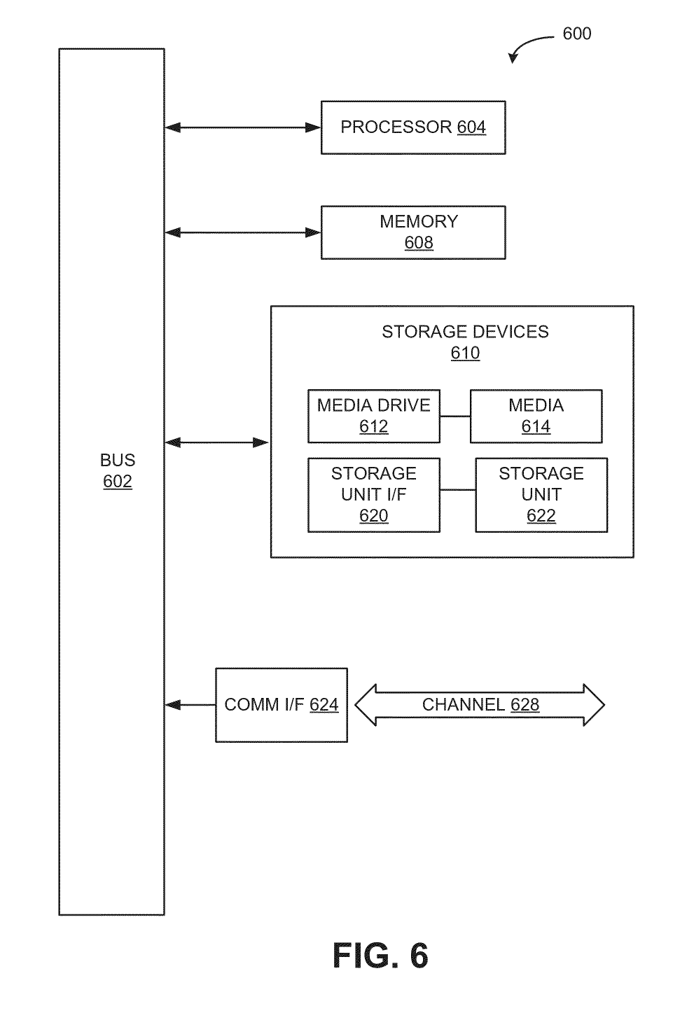

FIG. 6 illustrates example computing module 600, an example of which may include a processor/controller resident on a mobile device or POS terminal, or a processor/controller used to operate a payment transaction device. Computing module 600 may be used to implement various features and/or functionality of the systems and methods disclosed in the present disclosure.

As used herein, the term module might describe a given unit of functionality that may be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described may be shared in part or in total among one or more modules. In other words, as would be apparent to one of ordinary skill in the art after reading this description, the various features and functionality described herein may be implemented in any given application and may be implemented in one or more separate or shared modules in various combinations and permutations. Even though various features or elements of functionality may be individually described or claimed as separate modules, one of ordinary skill in the art will understand that these features and functionality may be shared among one or more common software and hardware elements, and such description shall not require or imply that separate hardware or software components are used to implement such features or functionality.

Where components or modules of the application are implemented in whole or in part using software, in one embodiment, these software elements may be implemented to operate with a computing or processing module capable of carrying out the functionality described with respect thereto. One such example computing module is shown in FIG. 6. Various embodiments are described in terms of example computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, and tablet computers; hand-held computing devices (tablets, PDA's, smartphones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium may be used to facilitate interaction with other components of computing module 600 or to communicate externally.

Computing module 600 might also include one or more memory modules, simply referred to herein as main memory 608. For example, preferably random access memory (RAM) or other dynamic memory might be used for storing information and instructions to be executed by processor 604. Main memory 608 might also be used for storing temporary variables or other intermediate information during execution of instructions to be executed by processor 604. Computing module 600 might likewise include a read only memory (“ROM”) or other static storage device coupled to bus 602 for storing static information and instructions for processor 604.

The computing module 600 might also include one or more various forms of information storage devices 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), or other removable or fixed media drive might be provided. Accordingly, removable storage media 614 might include, for example, a hard disk, a floppy disk, magnetic tape, cartridge, optical disk, a CD or DVD, or other fixed or removable medium that is read by, written to or accessed by media drive 612. As these examples illustrate, removable storage media 614 may include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit 622 and a storage unit interface 620. Examples of such removable storage units 622 and storage unit interfaces 620 may include a program cartridge and cartridge interface, a removable memory (for example, a flash memory or other removable memory module) and memory slot, a PCMCIA slot and card, and other fixed or removable storage units 622 and storage unit interfaces 620 that allow software and data to be transferred from removable storage unit 622 to computing module 600.

Computing module 600 might also include a communications interface 624. Communications interface 624 might be used to allow software and data to be transferred between computing module 600 and external devices. Examples of communications interface 624 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 might typically be carried on signals, which may be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 608, storage unit interface 620, removable storage media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

Various embodiments have been described with reference to specific example features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various example embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present application, whether or not such embodiments are described and whether or not such features are presented as being a part of a described embodiment. Thus, the breadth and scope of the present application should not be limited by any of the above-described example embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide illustrative instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed in multiple groupings or packages or across multiple locations.

Additionally, the various embodiments set forth herein are described in terms of example block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

What is claimed is:

1. A payment network, comprising:
a server;
a processor; and
a memory module comprising stored computer program code, wherein the memory module, the stored computer program code, and the processor are configured to cause the server to:
parse a request message associated with a payment transaction to obtain an item identifier associated with an item to be purchased as part of the payment transaction, and to obtain payment mechanism information associated with a payment mechanism;
obtain a determination of whether, based on the payment mechanism information, the payment mechanism complies with a set of pricing control rules associated with the item;
transmit a response message approving the payment transaction request, upon a determination that the payment mechanism complies with the set of pricing control rules; and
transmit a response message declining the payment transaction request, upon a determination that the payment mechanism does not comply with the set of pricing control rules.

2. The payment network of claim 1, wherein the set of pricing control rules comprises a geographical territory associated with the item, and wherein the payment mechanism complies with the set of pricing control rules only if the payment mechanism was issued within the geographical territory associated with the item.

3. The payment network of claim 1, wherein the set of pricing control rules comprises a geographical territory and a minimum price for the item, the minimum price specific to the geographical territory, and wherein the payment mechanism complies with the set of pricing control rules only if the payment mechanism was issued within the geographical territory and a purchase price of the item is greater than or equal to the minimum price.

4. The payment network of claim 1, wherein the item identifier is provided from one of a mobile device payment application and a merchant point-of-sale (POS) terminal, and wherein the request message is contained in an authorization request message.

5. The payment network of claim 1, further comprising a clearing system configured to process clearing and settlement associated with the payment transaction, only after the determination that the payment mechanism complies with the set of pricing control rules.

6. The payment network of claim 5, wherein the clearing system is further configured to withhold from processing clearing and settlement associated with the payment transaction, subsequent to the determination that the payment mechanism does not comply with the set of pricing control rules.

7. The payment network of claim 1, wherein the item is published content selected from the group consisting of books, magazines, periodicals, journals, digital media, streaming video, and streaming audio.

8. A non-transitory computer-readable medium having computer-executable program code embodied thereon, the computer-executable program code configured to cause a payment network to:
receive a request for authorization of a purchase transaction associated with an item to be paid for by a purchaser using a payment card;
obtain item identification information and payment card information from purchase transaction information associated with the request for authorization, the item identification information associated with the item, the payment card information associated with the payment card;
determine, based on the payment card information and the item identification information, whether the payment card conforms to a set of pricing control rules associated with the item, the set of pricing control rules comprising a geographical territory specific to the item; and
authorize the purchase transaction, upon the payment network determining that the payment card conforms to the set of pricing control rules;
wherein the payment card conforms to the set of pricing control rules only if the payment card was issued within the geographical territory.

9. The non-transitory computer-readable medium of claim 8, wherein the payment network comprises a clearing system, and wherein the computer-executable program code is configured to cause the clearing system to transmit a clearing message for the purchase transaction only upon the payment network authorizing payment for the item.

10. The non-transitory computer-readable medium of claim 9, wherein the computer-executable program code is further configured to cause the payment network to initiate payment settlement subsequent to the clearing system transmitting the clearing message.

11. The non-transitory computer-readable medium of claim 8, wherein the computer-executable program code is further configured to cause the payment network to transmit the item identification information and the payment card information to an item central repository associated with an item licensor to allow the item licensor to compare the payment card information to the set of pricing control rules to ascertain whether the payment card information conforms to the set of pricing control rules, and wherein the set of pricing control rules is stored in the item central repository.

12. The non-transitory computer-readable medium of claim 8, wherein the item comprises published content, and wherein the geographical territory is a country.

13. A method for enforcing a pricing structure, the method comprising:
receiving a request message at a payment network, the request message associated with a request to purchase an item using a payment mechanism, the request message comprising:
an item identifier that identifies the item; and
payment mechanism information associated with the payment mechanism;
processing the request message to generate a comparison of the payment mechanism information to one or more pricing control rules associated with the item; and
transmitting by the payment network a response message containing an approval or a decline of the request to purchase the item, the approval or decline based on the comparison.

14. The method of claim 13, wherein the one or more pricing control rules comprises a geographical territory associated with the item, and wherein the response message contains an approval only if the payment mechanism was issued within the geographical territory associated with the item.

15. The method of claim 13, wherein transmitting the response message comprises transmitting the response message to at least one of an acquiring bank associated with a merchant of the item, and an issuing bank associated with a purchaser of the item.

16. The method of claim 13, further comprising transmitting the request message to a verification network associated with an item licensor, wherein processing the request message is done by the verification network.

17. The method of claim 13, further comprising transmitting a transaction log to an item licensor, the transaction log comprising:
a set of the request messages; and
a set of the response messages, each of the response messages corresponding to one of the request messages.

18. The method of claim 13, wherein transmitting the response message comprises transmitting the response message to a distributor of the item to prevent the distributor from distributing the item unless the response message contains an approval.

19. The method of claim 13, wherein processing the request message is done before the purchase request is cleared by the payment network, and wherein the payment network does not clear the purchase request unless the response message contains an approval.

20. The method of claim 13, wherein the request message is an authorization request message, wherein processing the request message is done before the purchase request is authorized, and wherein the purchase request is not authorized unless the response message contains an approval.
